(19) United States
(12) Patent Application Publication
(10) Pub. No.: US 2004/0067405 A1
(43) Pub. Date: Apr. 8, 2004

(54) Flow field plate geometries

(76) Inventors: Mark Christopher Turpin, Leicestershire (GB); James Charles Boff, Middlesex (GB); Alan Robert Begg, Warwickshire (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/467,258

(22) PCT Filed: Feb. 5, 2002
(86) PCT No.: PCT/GB02/00479

(30) Foreign Application Priority Data
Feb. 12, 2001 (GB) 0103390.1

(51) Int. Cl. H01M 8/02; H01M 8/10; C25B 9/08; C25C 7/04

(52) U.S. Cl. 429/38; 429/39; 429/32; 204/269

(57) ABSTRACT

A flow field plate for a fuel cell comprising at least one channel extending from a source of fluid to a drain for said fluid, in which the cross-sectional area of said channel at drain or source is less than 95% of the cross-sectional area at source or drain respectively.

This invention relates to fuel cells and electrolysers, and is particularly applicable to proton exchange membrane fuel cells and electrolysers.

Fuel cells are devices in which a fuel and an oxidant combine in a controlled manner to produce electricity directly. By directly producing electricity without intermediate combustion and generation steps, the electrical efficiency of a fuel cell is higher than using the fuel in a traditional generator. This much is widely known. A fuel cell sounds simple and desirable but many man-years of work have been expended in recent years attempting to produce practical fuel cell systems. An electrolyser is effectively a fuel cell in reverse, in which electricity is used to split water into hydrogen and oxygen. Both fuel cells and electrolysers are likely to become important parts of the so-called “hydrogen economy”. In the following, reference is made to fuel cells, but it should be remembered that the same principles apply to electrolysers.

One type of fuel cell in commercial production is the so-called proton exchange membrane (PEM) fuel cell [sometimes called polymer electrolyte or solid polymer fuel cells (PEFCs)]. Such cells use hydrogen as a fuel and comprise an electrically insulating (but ionically conducting) polymer membrane having porous electrodes disposed on both faces. The membrane is typically a fluorosulphonate polymer and the electrodes typically comprise a noble metal catalyst dispersed on a carbonaceous powder substrate. This assembly of electrodes and membrane is often referred to as the membrane electrode assembly (MEA).

Hydrogen fuel is supplied to one electrode (the anode) where it is oxidised to release electrons to the anode and hydrogen ions to the electrolyte. Oxidant (typically air or oxygen) is supplied to the other electrode (the cathode) where electrons from the cathode combine with the oxygen and the hydrogen ions to produce water. A sub-class of proton exchange membrane fuel cell is the direct methanol fuel cell in which methanol is supplied as the fuel. This invention is intended to cover such fuel cells and indeed any other fuel cell using a proton exchange membrane.

In commercial PEM fuel cells many such membranes are stacked together separated by flow field plates (also referred to as separators or bipolar plates). The flow field plates are typically formed of metal or graphite to permit good transfer of electrons between the anode of one membrane and the cathode of the adjacent membrane.

The flow field plates have a pattern of grooves on their surface to supply fluid (fuel or oxidant) and to remove water produced as a reaction product of the fuel cell. Flow fields may also be provided to supply coolant fluids. Various methods of producing the grooves have been described, for example it has been proposed to form such grooves by machining, embossing or moulding (WO00/41260), and (as is particularly useful for the present invention) by sandblasting (or other etching using the momentum of moving particles to abrade the surface) through a resist (WO01/04982).

International patent application No. WO01/04982 disclosed a method of machining flow field plates by means of applying a resist or mask to a plate and then using sandblasting (or other etching method using the momentum of moving particles to abrade the surface, e.g. waterjet machining), to form features corresponding to a pattern formed in the mask or resist.

Such a process was shown by WO01/04982 as capable of forming either holes through the flow field plates, or closed bottom pits or channels in the flow field plates. The process of WO01/04982 is incorporated herein in its entirety, as giving sufficient background to enable the invention.

In practice, the majority of plates made to date have been formed by milling the channels. It has been viewed as a drawback in the past that in milling, tool wear can result in a tapered channel. The taper is not readily controllable. Ordinarily the aim is to form the channels with straight sides to a tolerance of +−25 μm.

An assembled body of flow field plates and membranes with associated fuel and oxidant supply manifolds is often referred to a fuel cell stack.

Although the technology described above has proved useful in prototype and in some limited commercial applications, to achieve wider commercial acceptance there is now a demand to reduce the cost of flow field plates and to improve on the range of geometries that can be used to improve performance.

WO00/41260 describes in detail the advantages and disadvantages of existing flow field plate designs. In particular, it discusses the need to maintain a pressure drop across the plate to reduce or eliminate the accumulation of water; and the drawback of increasing the pressure differential, namely larger parasitic energy demands.

WO00/41260 also discusses the problems of eddy formation near bends in serpentine channels.

The approach to overcoming these various problems suggested by WO00/41260 is to provide a straight channelled flow field plate, and to increase the length of the channels and decrease their width in comparison with earlier straight channelled flow field plates.

WO00/41260 also discusses the drawbacks of conventional milling tools for making such channels, and particularly the tool wear that makes it difficult to reproducibly form narrow channels of a consistent width. The suggestion in WO00/41260 is that such narrow channels could be produced by moulding or embossing. However moulding or embossing the plates limits the materials from which they can be made so that a compromise between fine features and material properties would have to be made.

The applicants have realised that if channels with reproducibly diminishing cross-section could be formed in flow field plates then the diminishing cross-section could be used to provide a uniform pressure drop across the plate and to provide a varying carrying capacity across the plate. Such diminishing cross-section channels would be of advantage for almost any flow field plate geometry.

Accordingly the present invention provides a flow field plate for a proton exchange membrane fuel cell or electrolyser comprising at least one channel extending from a source of fluid to a drain for said fluid, in which the cross-sectional area of said channel at drain or source is less than 95% of the cross-sectional area at source or drain respectively.

Preferably the cross-sectional area of said channel at drain or source is less than 75% of the cross-sectional area at source or drain respectively.

The channel may cross an electrochemically active region in the flow field, with the cross-sectional area of said channel at one side of said electrochemically active region being less than 95% of the cross-sectional area at another side of the electrochemically active region.

Further details of the invention will become apparent from the claims and the following description with reference to the drawings in which:—

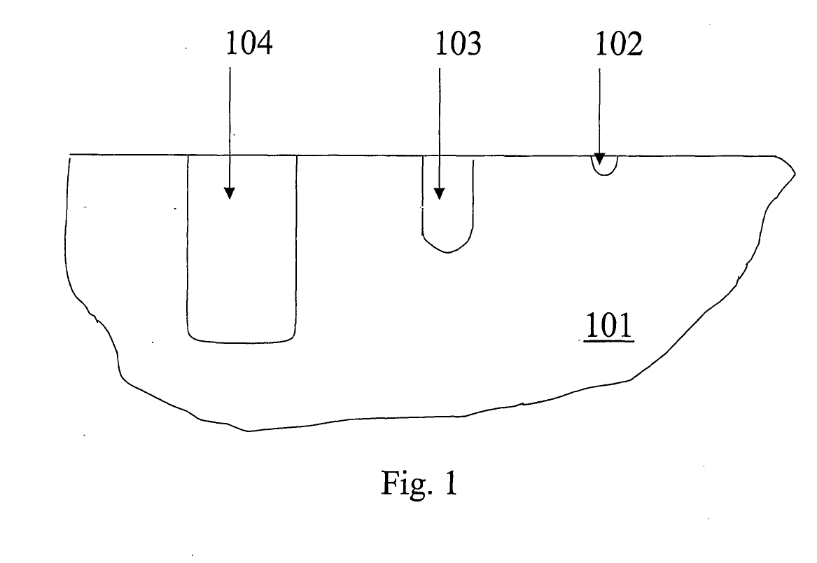

FIG. 1 shows schematically in part section a part of a fluid flow plate incorporating gas delivery channels and gas diffusion channels formed by an abrasive air blast technique (sandblasting).

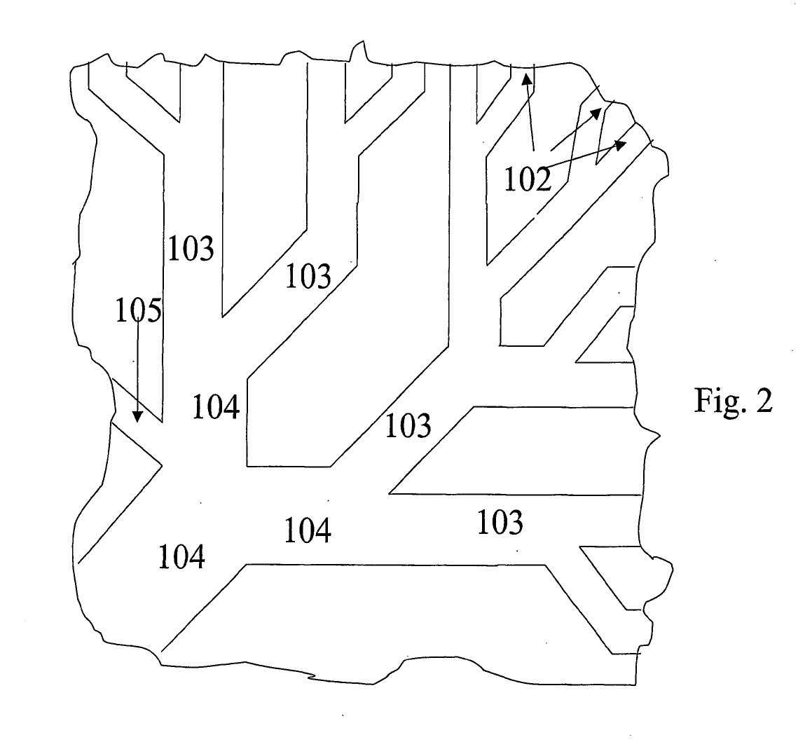

FIG. 2 shows schematically a partial plan view of a fluid flow plate incorporating gas delivery channels and gas diffusion channels.

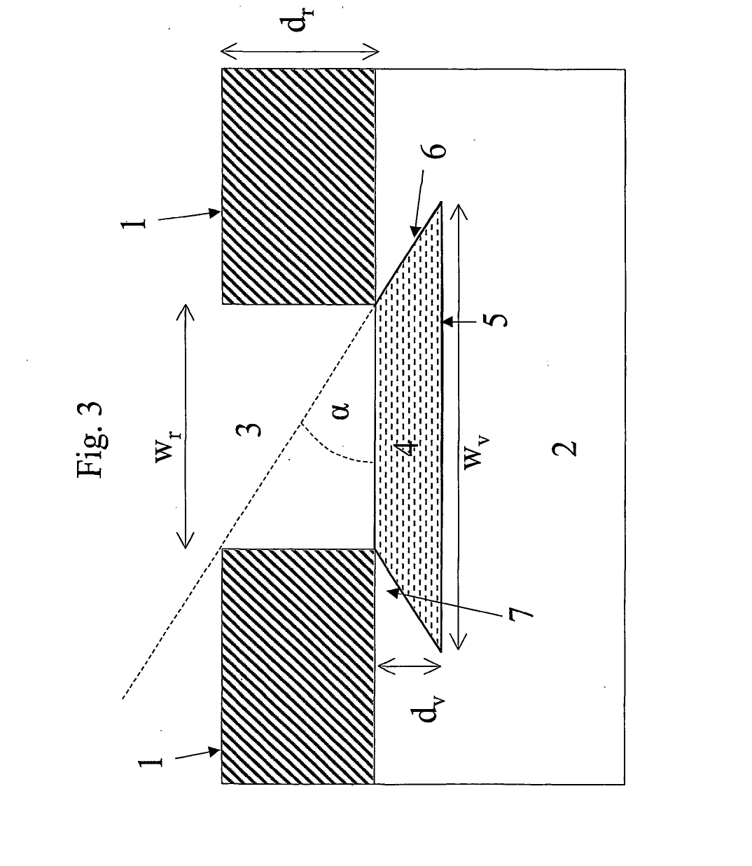

FIG. 3 is a schematic drawing illustrating one method of undercutting a channel;

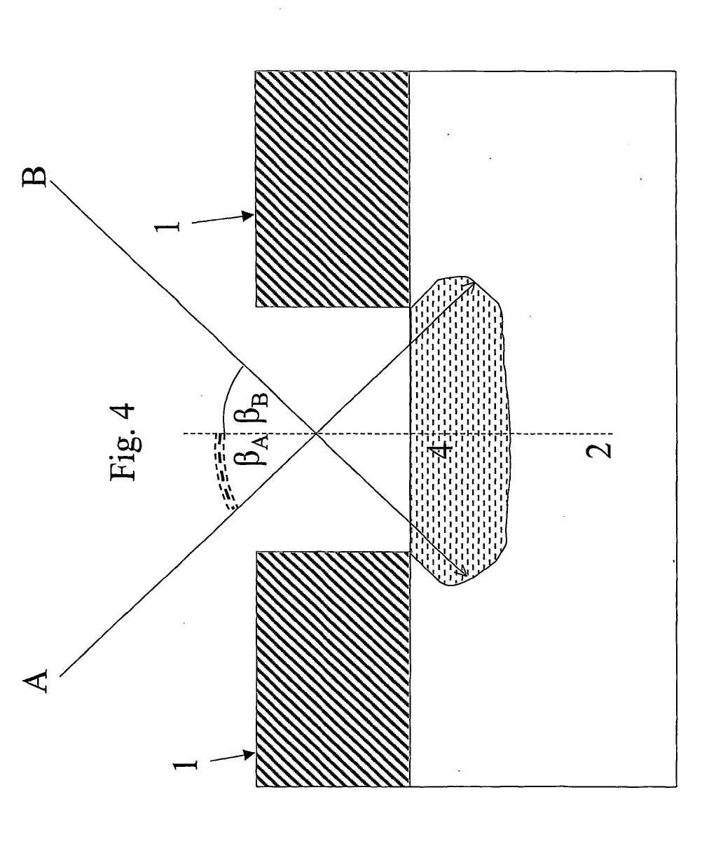

FIG. 4 is a schematic drawing showing by way of example limitations of the technique of the method of FIG. 3;

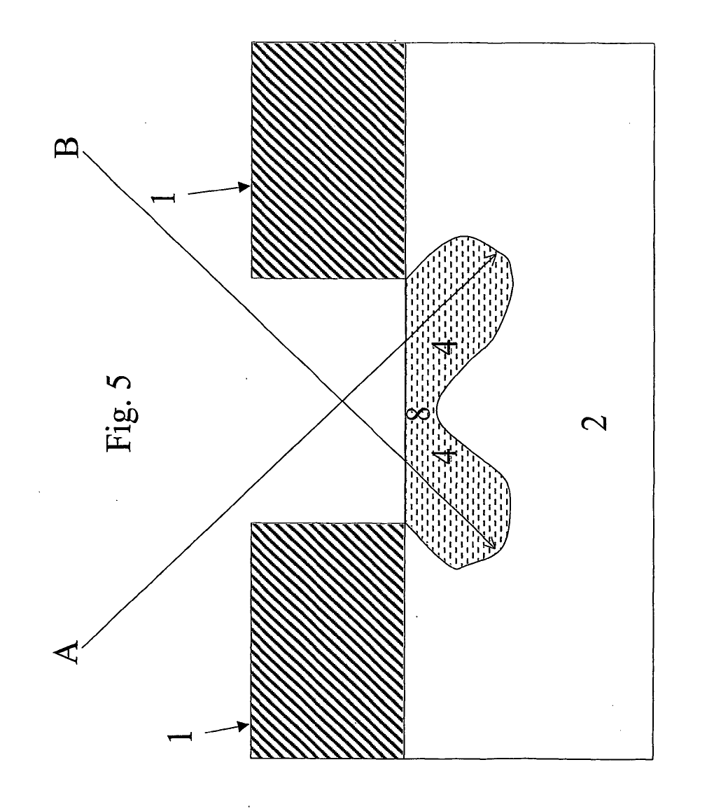

FIG. 5 is a schematic drawing showing a further method of performing the method of FIG. 3;

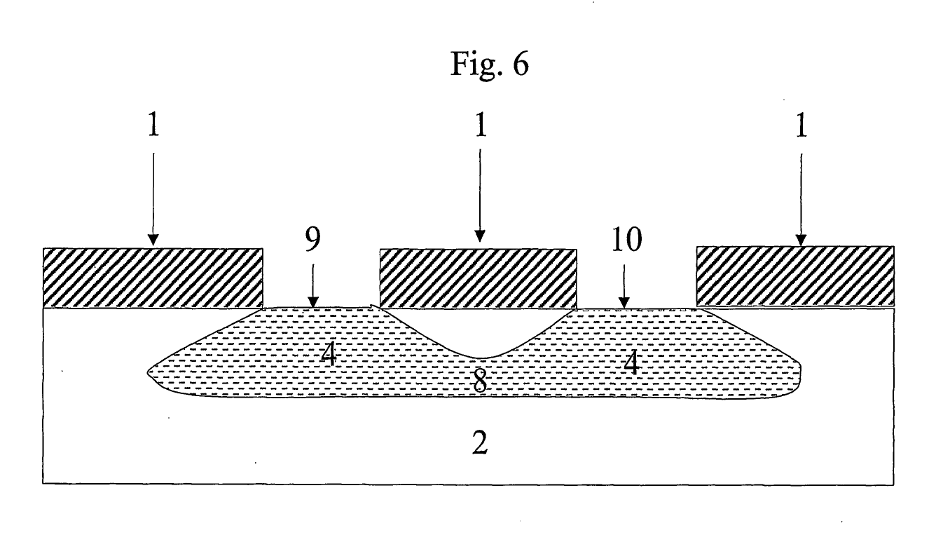

FIG. 6 is a schematic drawing showing a still further method of performing the method of FIG. 3;

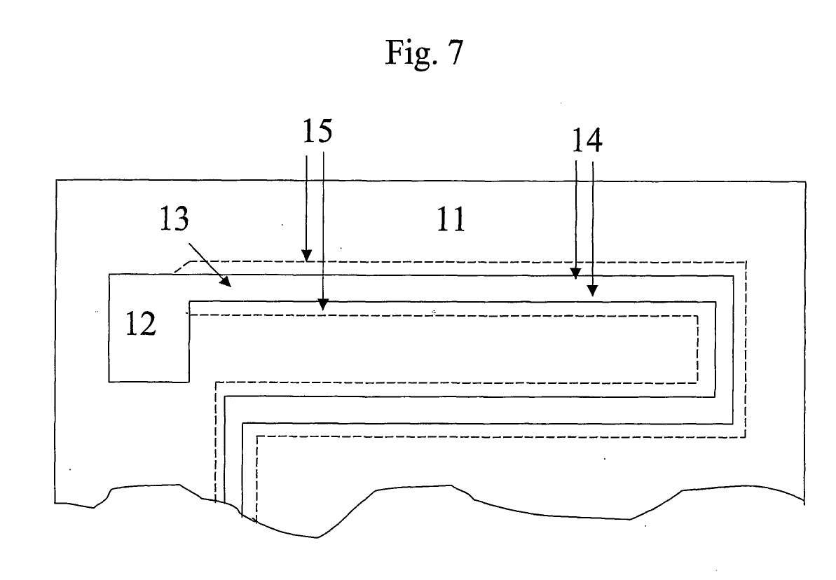

FIG. 7 is a schematic drawing showing in partial plan a channel in a flow field plate;

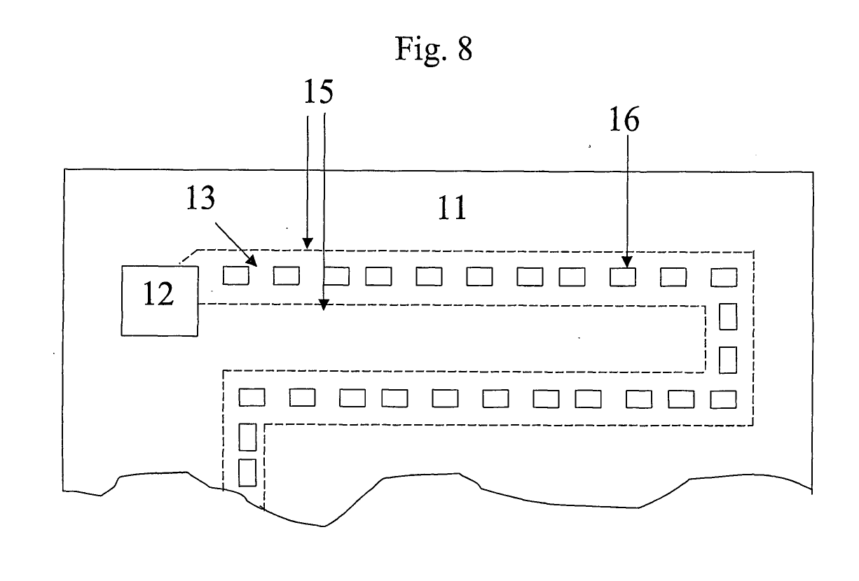

FIG. 8 is a schematic drawing in partial plan showing a further channel in a flow field plate;

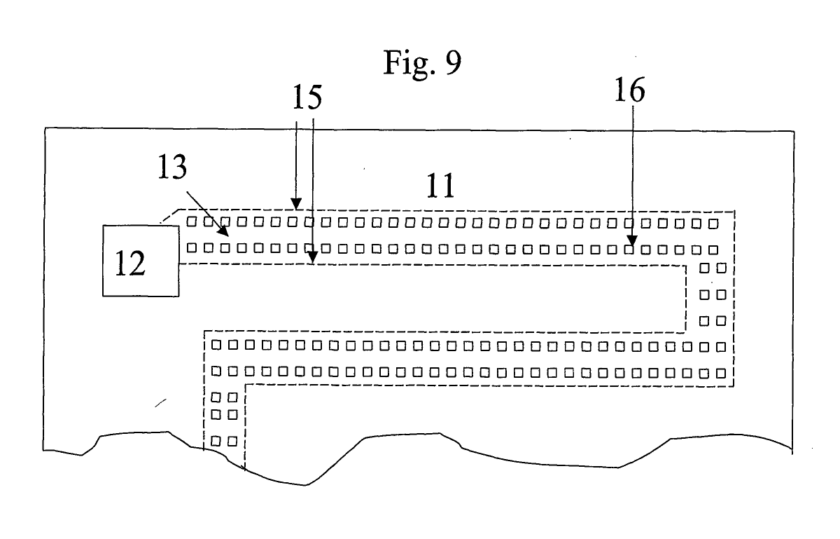

FIG. 9 is a schematic drawing in partial plan showing a yet further channel in a flow field plate;

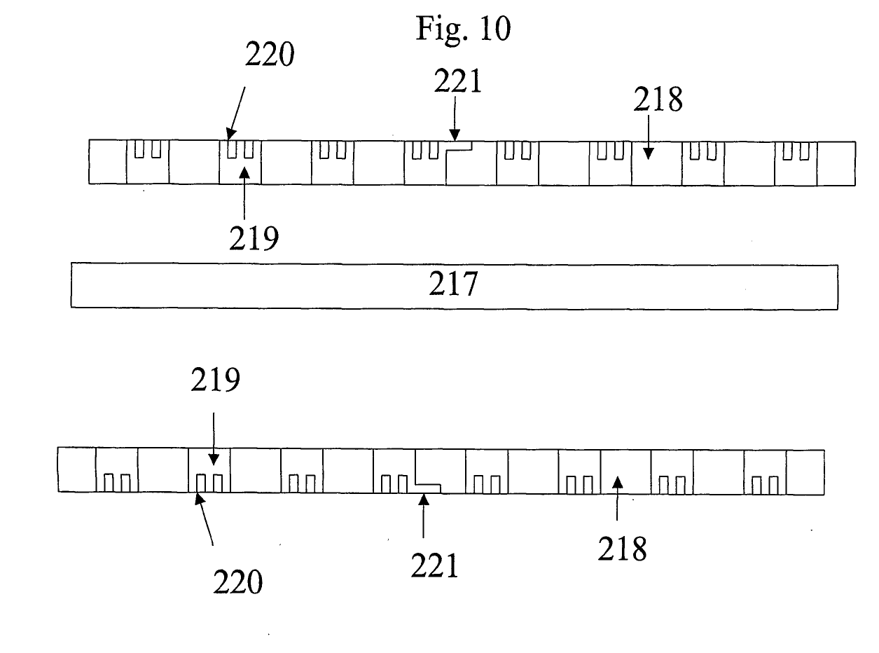

FIG. 10 is a schematic drawing showing in section and alternative construction of flow field plate;

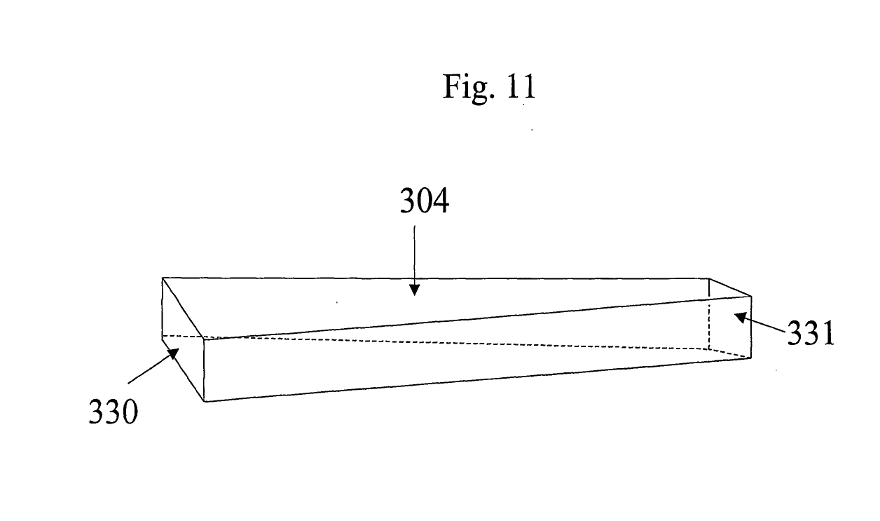

FIG. 11 is a schematic view of a channel in a flow field plate;

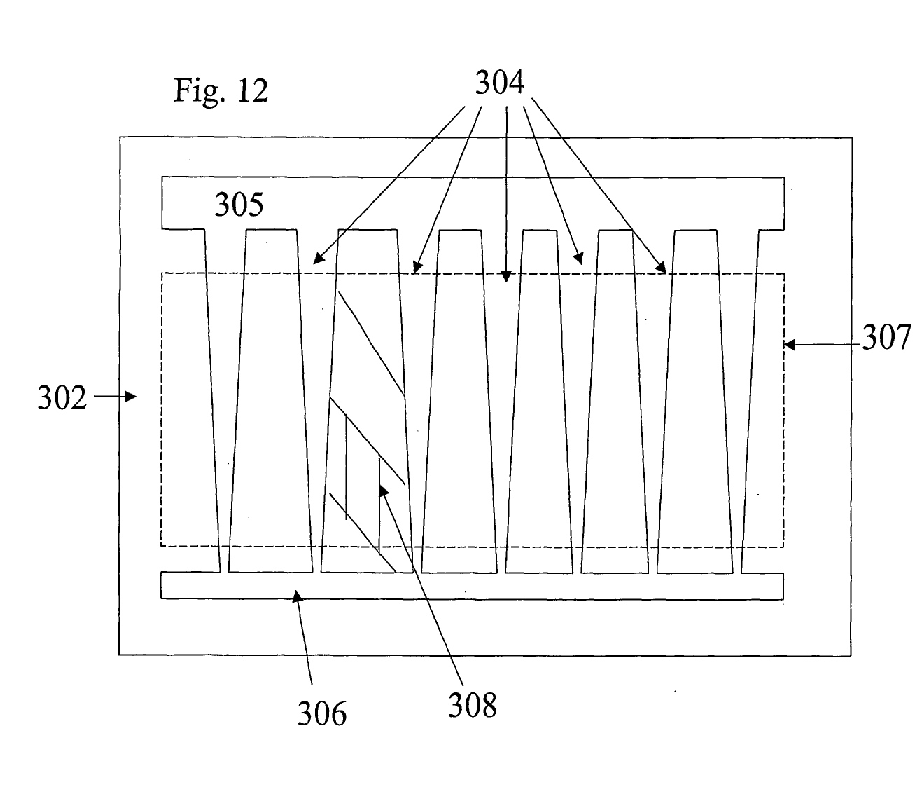

FIG. 12 is a schematic view of a flow field plate geometry;

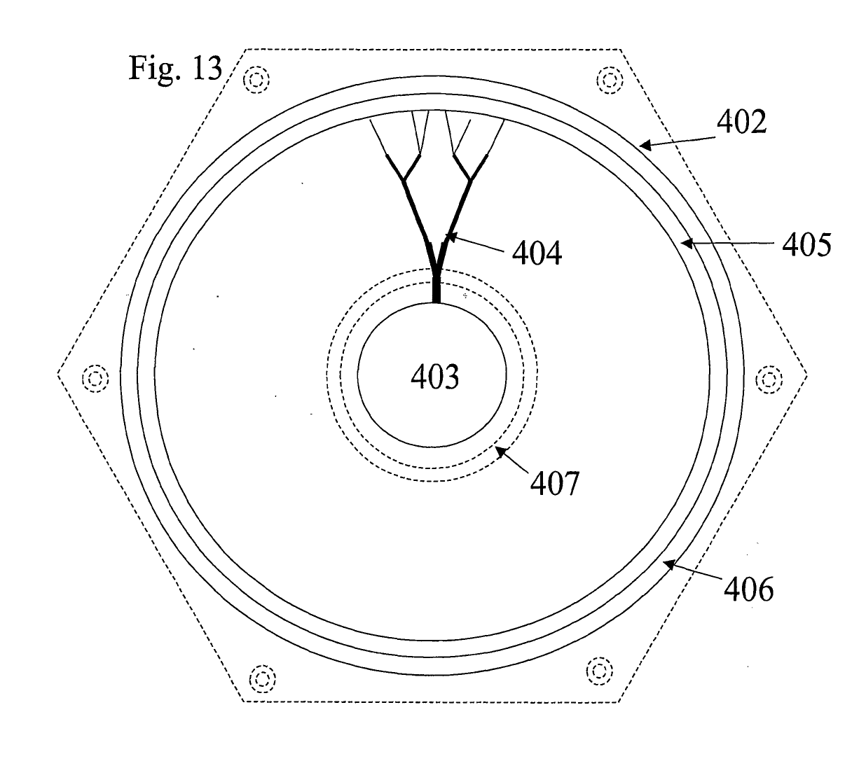

FIG. 13 is a schematic view of a further flow field plate geometry;

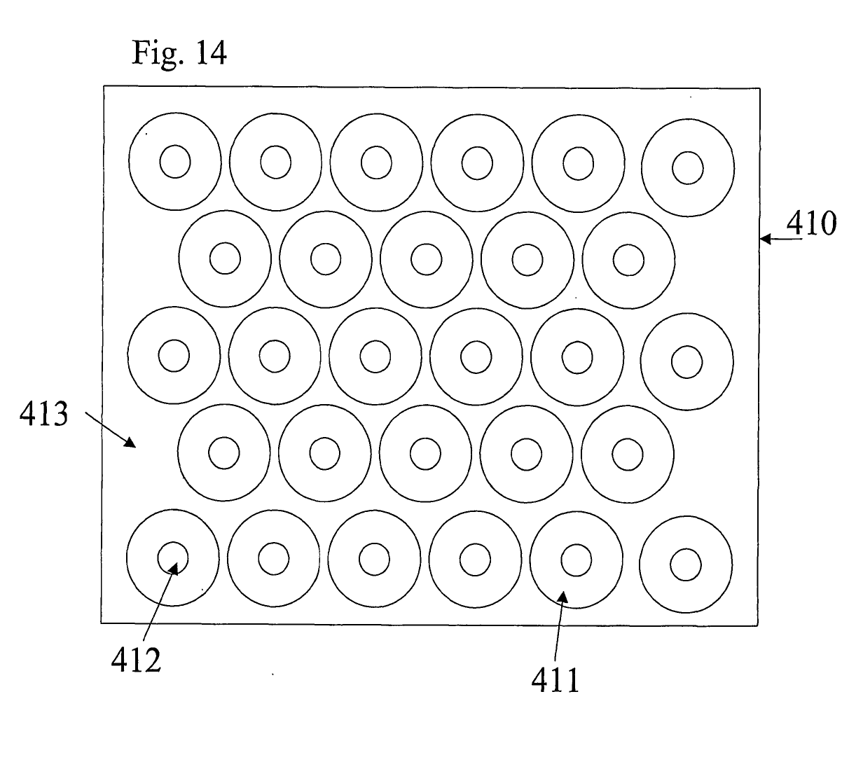

FIG. 14 is a schematic view showing a use of the flow field plate geometry of FIG. 13;

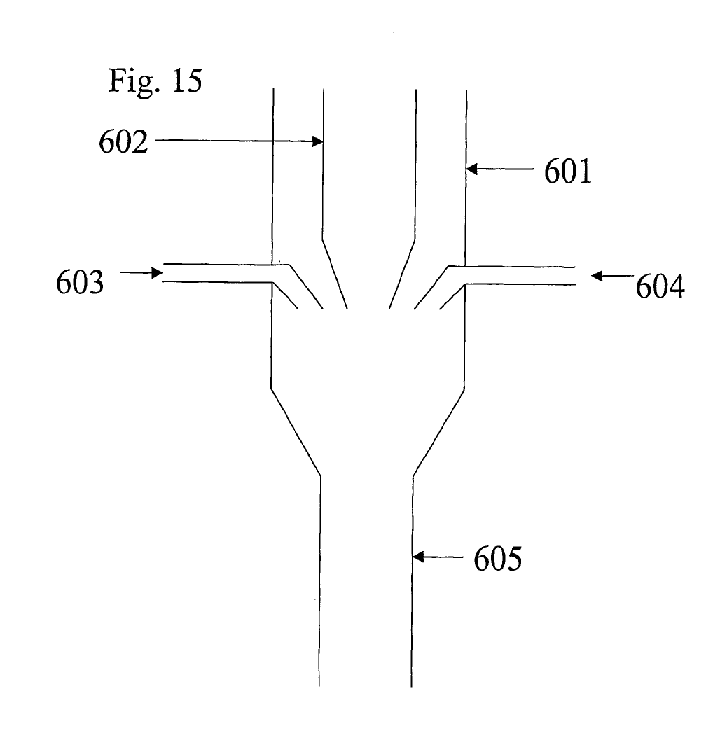

FIG. 15 is a schematic view of an abrasive gun for use in the invention;

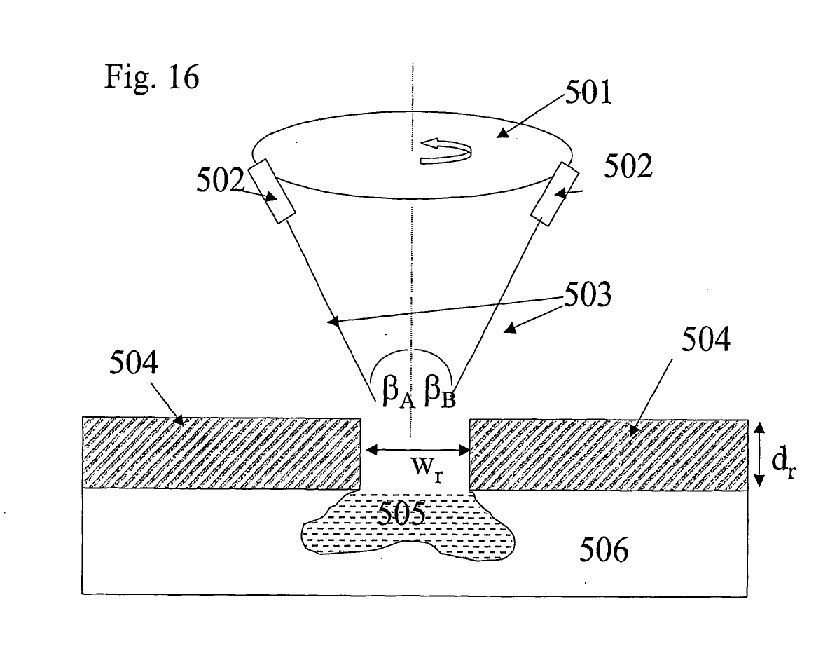

FIG. 16 is a schematic view illustrating the use of a multiple headed gun.

The following description will refer to the manufacture of flow field plates by abrasive blasting (sandblasting) through a resist, but aspects of the invention are not limited to this method of manufacture.

To form both gas delivery and gas diffusion channels a technique such as abrasive blasting may be used in which a template or resist is placed against the surface of a plate, the template or resist having a pattern corresponding to the desired channel geometry. Such a technique is described in WO01/04982, which is incorporated herein in its entirety as enabling the present invention.

With this technique the plates may be formed from a graphite/resin composite or other non-porous electrically conductive material that does not react significantly with the reactants used. The type of abrasive blasting much preferred is the use of an air blast. Waterjet machining is generally found to be too aggressive for easy control, but with care and good control equipment would be possible.

Alternative methods for forming such fine features include the use of excimer laser ablation or chemical etching, but neither process offers the low cost achievable by the present process.

It is found with this technique that the profiles of channels of different width vary due to the shadow cast by the mask. FIG. 1 shows a flow field plate 101 having a narrow channel 102 formed in its surface. Because of the shadowing effect of the resist used in forming the channel the channel is exposed to sandblast grit coming effectively only from directly above. This leads to a generally semicircular profile to the channel and to a shallow cutting of the channel.

For progressively larger channels (103 and 104) the resist casts less of a shadow allowing sandblasting grit from a progressively wider range of angles to strike the surface of the flow field plate, so allowing both deeper cutting of the surface and a progressively flatter bottom to the channel.

Accordingly, by applying a resist with different width channels to a plate and exposing the plate and resist to sandblasting with a fine grit, a pattern of channels of different widths and depths can be applied.

Applying such a pattern of channels of varying width and depth has advantages. In flow field plates the purpose behind the channels conventionally applied is to try to ensure a uniform supply of reactant material to the electrodes and to ensure prompt removal of reacted products. However the length of the passage material has to travel is high since a convoluted path is generally used.

Another system in which the aim is to supply reactant uniformly to a reactant surface and to remove reacted products is the lung. In the lung an arrangement of progressively finer channels is provided so that air has a short pathway to its reactant site in the lung, and carbon dioxide has a short pathway out again. By providing a network of progressively finer channels into the flow field plate, reactant gases have a short pathway to their reactant sites.

The finest channels could simply discharge into wide gas removal channels or, as in the lung, a corresponding network of progressively wider channels could be provided out of the flow field plate. In the latter case, the two networks of progressively finer channels and progressively wider channels could be connected end-to-end or arranged as interdigitated networks, with diffusion through the electrode material providing connectivity. Connection end-to-end provides the advantage that a high pressure will be maintained through the channels, assisting in the removal of blockages.

The question of interconnected channels vs. blind channels depends on which side of the electrode we are dealing with. Hydrogen ions travel from the anode, through the polymer, and are made into water at the cathode. All of the water is made on the cathode side (air or oxygen side) of the cell. The water generation on the cathode side means that the air side gas channels cannot be blind ended, as this would cause flooding. Interdigitated will also be tricky unless a GDL is used as the permeability of the electrode is not high. Interdigitated channels also restrict the removal of impurities from the supply gas. Accordingly, the model wherein the branched channels join end to end or drain to a larger channel is preferred.

FIG. 2 shows in a schematic plan a portion of a flow field plate having broad primary gas delivery channels 104, which diverge into secondary gas delivery channels 103 which themselves diverge into gas diffusion channels 102. Gas diffusion channels 105 can also come off the primary gas deliver channels 104 if required. The primary and secondary gas delivery channels may each form a network of progressively finer channels as may the gas diffusion channels and the arrangement of the channels may resemble a fractal arrangement.

The primary gas delivery channels may have a width of greater than 1 mm, for example about 2 mm. A typical depth of such a channel is 0.25 mm but depth is limited only by the need to have sufficient strength in the flow field plate after forming the channel. The secondary gas delivery channels may have a width of less than 1 mm, for example 0.5 mm and, using the sandblasting technique may be shallower than the primary gas delivery channels. The gas diffusion channels have a width of less than 0.2 mm, for example about 100 μm and may be shallower still.

The flow field plates may be used with a gas diffusion layer, or the gas diffusion channels may be provided in a sufficient density over the surface of the flow field plate to provide sufficient gas delivery that a gas diffusion layer may be omitted.

When acting as a fuel cell, the gas delivery channels deliver gas to the gas diffusion channels which disperse the gas across the face of the flow field plate. When acting as an electrolyser the gas diffusion channels act to receive the gas from across the face of the flow field plate and the gas delivery channels deliver the gas for collection.

For the sandblasting technique, the limit on channel width is a function of the mask thickness used in the sand blast process. Image Pro™ materials (Chromaline Corp. US), are very thick at 125 micron. These masks limit track width to about 100 microns. Other mask materials can be spray coated onto the substrate and exposed in situ. These materials are much more resilient and hence can be much thinner. Chromaline SBX™ can be used to etch features down to 10-20 microns wide.

Various mask types may be used:—

a) adhesively mounted sheet masks

b) masks that are applied by painting, spraying, screen printing or any other such method to cover the desired surface of the article and then treated to selectively remove areas

c) masks that are applied and re-used

d) masks that are directly printed or applied to the surface (e.g. by ink blast printing) the invention is not restricted to any particular form of mask, but types b) and d) lend themselves most readily to mass production.

Of course, the abrasive material used in the abrasive blast must have a finer particle size than the feature to be formed. However, finer particle size leads to a lessening in the abrasion rate. The applicants have found it useful to use a relatively coarse abrasive material in the blast (e.g. 50 μm to 250 μm diameter silica or alumina grit) to form the wide channels, followed by use of a fine abrasive material (e.g. 5-20 μm diameter silica or alumina grit) to form the finer features. As explained further below, the coarse and fine materials may be mixed and applied in one step. The invention is not limited to any particular abrasive material.

Preferred materials for the plate are graphite, carbon-carbon composites, or carbon-resin composites. However the invention is not restricted to these materials and may be used for any material of suitable physical characteristics, with suitable choice of abrasive.

The use of angled blasts of abrasive materials is advantageous. The schematic drawing of FIG. 3 shows a resist 1 placed against a plate 2. The resist 1 has a thickness dᵣ and has an aperture 3 of width wᵣ. Abrasive materials projected through the aperture 3 has abraded the material of the plate to produce a void 4 of depth dᵥ and width wᵥ. Assuming that no particles bounced back from the lower surface 5 of the void 4 with sufficient strength to abrade the re-entrant surface 6, it can be seen that the minimum angle α of the re-entrant surface is determined by the lowest angle of approach of particles to the aperture 3. Therefore, for this configuration, the maximum void width can be calculated as:—

wᵥ=wᵣ+2*dᵥ*(wᵣ/dᵣ).

As examples, Table 1 below gives calculated void widths based on an assumed resist thickness of 0.125 mm and varying sizes of aperture and desired depths.

TABLE 1

| dᵣ (mm) | wᵣ (mm) | wᵥ (mm) | dᵥ (mm) |
|---|---|---|---|
| 0.125 | 0.75 | 6.75 | 0.5 |
| 0.125 | 0.5 | 4.5 | 0.5 |
| 0.125 | 0.2 | 1.8 | 0.5 |
| 0.125 | 0.1 | 0.9 | 0.5 |
| 0.125 | 0.75 | 3.75 | 0.25 |
| 0.125 | 0.5 | 2.5 | 0.25 |
| 0.125 | 0.2 | 1 | 0.25 |
| 0.125 | 0.1 | 0.5 | 0.25 |

In practice, sandblasting does not produce a mathematical point sized cutting tool and such would be required to produce a void of the shape shown in FIG. 3. Also, the angle of undercut produced is dependent upon the angle of incidence of the abrasive particles produced by the sandblast, provided that this is not shallower than α. If the angle of incidence of the abrasive particles produced by the sandblast is shallower than a then the plate 2 will be in the shadow of the resist and little or no abrasion of the surface by the sandblast will occur.

In practice a void shape somewhat as shown in FIG. 4 would be likely to result from a uniform sandblasting from a range of different directions from directions ‘A’ to ‘B’ and the angle of undercut produced would be β_{A} and α_{B} respectively, which will be close to the angles between the flow direction A and B of the abrasive material and a line normal to the face of the plate. (As the sandblast will have a degree of divergence the angle of undercut will not match the angles of flow direction A and B exactly). These angles are shown as the same in FIG. 4 but need not be so.

To a large extent the void shape can be tailored by directing different strength blasts from different directions, or by directing the blasts for different times from different directions, or by a combination of both. As an example, a void as shown in FIG. 5 could be produced by successively blasting from directions ‘A’ and ‘B’ to provide voids 4 meeting at neck 8.

It will be appreciated that FIGS. 3 to 5 are schematic, and exaggerated in showing the resist as having a great thickness. This means that the degree of undercut is shown as small. In practice, with a thin resist, a highly undercut void can be achieved. However, the greater the angle of undercut β the thinner the overhang 7 to the void 4 will be at its tip. The appropriate angle of undercut β for a given material will depend upon the strength required for the application. Advantageously the angle of undercut is greater than 20°, and preferably greater than 30°. More preferably the angle of undercut is greater than 40°. Angles of undercut of less than 60° are preferred for strength, although angles beyond this are possible and indeed advantageous for some geometries.

As is illustrated in FIG. 6, if the mask aperture spacing and blast directions are appropriately chosen, a pair of closely spaced voids 4 may merge at a neck 8 to form a single void connecting adjacent ports 9 and 10 at the surface.

The application of this technique to the manufacture of flow field plates is illustrated in FIGS. 7 to 9, in which a plate 11 has a fluid entry port 12. As shown in FIG. 7, the fluid entry port 12 connects at the surface of the plate 1 to a channel 13. Channel 13 has edges 14 defining its width at the surface. The channel 13 has a greater width within the body of the plate 1 than at the face of the plate 1 and may have, for example, a cross section as in any of FIGS. 3 to 5, in which the mouth of the channel cross-section is narrower than the interior of the channel cross-section within the body of the plate.

The maximum width of the channel 13 is shown as lines 15. Such a flow field plate can have shallower channels than a narrow parallel-sided channel of equivalent cross sectional area and this enables thinner flow field plates to be used. Gas channels in typical bipolar plates are of square or rectangular section and are millimetric in size. E.g. Ballard™ plates have a 2.5 mm square section channel. APS™ plates have a channel that is 0.9 mm wide by 0.6 mm deep. Taking a channel of the cross-section of FIG. 3, from basic geometry, the cross-sectional area of the channel will be equal to:—

wᵣ*dᵥ+2*(l/2dᵥ(dᵥ/tan α))

Table 2 below compares channels made to the present invention as shown in FIG. 3 with those of the known Ballard™ and APS™ plates.

TABLE 2

| | | Width at | Depth | Area |
|---|---|---|---|---|
| | α (°) | face (mm) | (mm) | (mm)² |
| Ballard ™ | 90 | 2.5 | 2.50 | 6.25 |
| To the | 60 | 2.5 | 1.77 | 6.25 |
| invention | 45 | 2.5 | 1.55 | 6.25 |
| | 30 | 2.5 | 1.31 | 6.25 |
| APS ™ | 90 | 0.9 | 0.60 | 0.54 |
| To the | 60 | 0.9 | 0.46 | 0.54 |
| invention | 45 | 0.9 | 0.41 | 0.54 |
| | 30 | 0.9 | 0.36 | 0.54 |

For a given depth and cross sectional area of channel, this geometry also gives a significantly narrower gap at the surface reducing the disadvantages of previous geometries as mentioned above. This is shown in Table 3 below.

TABLE 3

| | | Width at | Depth | Area |
|---|---|---|---|---|
| | α (°) | face (mm) | (mm) | (mm)² |
| Ballard ™ | 90 | 2.50 | 2.50 | 6.25 |
| To the invention | 60 | 1.06 | 2.50 | 6.25 |
| APS ™ | 90 | 0.90 | 0.60 | 0.54 |
| To the invention | 60 | 0.55 | 0.60 | 0.54 |
| | 45 | 0.30 | 0.60 | 0.54 |

Of course, these figures are calculated from an idealised geometry for the sandblasting technique and the actual dimensions achievable will differ. It will be appreciated that the angle α will differ for different width channels. This means that for a wide channel a greater degree of undercut is achievable than for a narrow channel. Also, the thickness of the resist will affect the angle α. Accordingly, by varying the width of channels and/or the thickness of resist it is possible to provide channels of differing degree of undercut by using the shadow of the resist.

FIG. 8 shows a similar geometry to FIG. 7, but made by piercing the plate at a number of ports 16 and undercutting around these ports to define the channel 13. In this arrangement the channels are interrupted at the face by regions bridging the channel to form a covered channel connecting ports in the face.

FIG. 9 shows a similar arrangement but in which adjacent pairs of ports are provided (as in FIG. 6).

To achieve sandblasting from different directions, multiple guns may be used, so that the abrasive materials are directed from a plurality of flow directions in one operation; or a single gun can be used successively from different directions; or multiple guns can be used successively from different directions. For example a sandblasting head comprising two or more guns mounted to direct their blasts in non-parallel directions (e.g. directions A and B in FIG. 3) can be traversed over a flow field plate.

As the blast sweeps across it will in effect successively expose the aperture in the resist to blasts from directions A and B. A similar effect could be achieved by successively traversing guns directed in directions A and B. If it was desired to flatten the hump underlying neck 8 then a gun directed normally to the surface of the plate 2 could be used. Such a gun could either form part of the sandblasting head, comprising two or more guns mounted to direct their blasts in non-parallel directions, or it could be a separate gun used in a separate operation.

As abrasive particles in the blast will not go into apertures smaller than their diameter then it is evident that one could use angularly directed coarse abrasives to form large undercut channels and, in a separate normally directed blast, fine abrasives to form non-undercut fine channels.

An alternative, but less preferred approach to forming undercut channels would be to maintain the direction of the abrasive in one direction, but to adjust the relative angle of the plate to this direction. This approach can be combined with that above.

It is readily apparent that this technique is not the only one that allows undercut geometries to be achieved. Excimer laser ablation could for example be used to mimic the sandblasting technique. An alternative would be to form the channels in a plastic material and then roll the material so that the edges of the channels are forced inwards.

A further alternative method of achieving undercut channels could be to form the flow field plate from two or more plates. FIG. 10 shows a central non-porous plate 217 and two plates 218 each having channels 219 formed in the side of the plates 218 adjacent the central non-porous plate 227. The channels 219 have ports 220 opening to the side of the plates 218 remote from the central non-porous plate 227. The ports 220 may have fine channels 221 leading from the ports 220 and lying in the side of the plates 218 remote from the central non-porous plate 217. The plates 218 could be made by the sandblasting method described above or indeed by any other method that appears suitable. Plates 217 and 218 are sandwiched together to form a combined flow field plate in which the flow field is buried within the resulting plate on either side of plate 227. The ports 220 serve to conduct fluid to/from the surface of the combined flow field plate and fine channels 221 may serve to conduct fluid across the surface of the combined flow field plate. (Such fine channels 221 in the surface of a flow field plate may also be used with the geometries of FIGS. 7 to 9).

Gas diffusion channels of less than 0.2 mm width are advantageously used to diffuse the gas coming from the channels 13.

It is evident that the plate 217 and one plate 218 could be combined to form a flow field on one side only of plate 217. In this case the plate 217 may optionally have a different geometry of flow field (for example, for coolant) formed in the side remote from the plate 217.

The applicants have further realised that if channels with reproducibly diminishing cross-section could be formed in flow field plates then the diminishing cross-section could be used to provide a uniform pressure drop across the plate and to provide a varying carrying capacity across the plate. Such diminishing cross-section channels would be of advantage for almost any flow field plate geometry.

At present, the advantage to diminishing cross-section channels applies primarily to the hydrogen side of the fuel cell. During operation hydrogen is consumed adjacent the electrochemically active region of the flow field so that less gas leaves the plate than is fed to it. A progressively diminishing channel therefore enables an even pressure drop to be provided across the electrochemically active region of the flow field.

The reduction in area required will vary according to the geometry of the fuel cell. A reduction to 95% of the initial cross-sectional area on entering the electrochemically active region of the flow field to leaving this region will give some useful effect, but the invention contemplates a reduction of much more, typically in the region of a reduction to 25-75% of the initial cross-sectional area on entering the electrochemically active region of the flow field, for example 30-50% of the initial cross-sectional area on entering the electrochemically active region of the flow field.

For channels which split into multiple channels the sum of the cross-sectional areas of the multiple channels on exiting the electrochemically active region of the flow field should be taken in calculating the reduction in cross-sectional area.

On the oxygen side, for each molecule of oxygen consumed two molecules of water are produced. At present, for commercially produced fuel cells, this water is generally produced as both liquid and vapour. However, as membrane technology improves to allow fuel cell operation above the boiling point of water, then more gas will leave the fuel cell than enters it. This could make a progressively widening channel advantageous to provide an even pressure gain across the cell.

The invention could be used for the coolant flow field too, particularly where the number of channels varies from one side of the flow field to the other.

It could be advantageous not to have a uniformly diminishing cross-section, so that the pressure drop can be controlled across the electrochemically active region of the flow field. This would allow some parts of the cell to run hotter than others, which can be of assistance in water management.

The diminishing/widening cross-section can be achieved either by tapering the channels, or by decreasing/increasing their depth, or both.

FIG. 11 shows schematically a single channel 304 in a flow field plate which tapers from one end 330 to the other end 331. The depth of tapering channel 304 is shown as being constant but it will be appreciated from the foregoing description that this is not necessarily so. The area at end 330 is less than that at the end 331. The channel will in use lie against a membrane electrode (with or without an intervening gas diffusion layer) and the area of the flow field adjacent the electrochemically active part of the membrane electrode will be referred to in the following as the electrochemically active region of the flow field.

FIG. 12 shows a flow field geometry that could be used. This combines tapering channels and a branching flow field geometry. Flow field plate 302 has a plurality of tapering channel 304 connecting a fuel gas supply channel 305 to a fuel gas drain channel 306. The channels taper in the electrochemically active area 307. Adjacent channel 304 may be connected by gas diffusion channels 308 which pass from regions of higher to lower pressure.

The applicants have realised that it may be possible to omit some of the channels used in conventional fuel cell arrangements. FIG. 13 shows an alternative form of flow field in which flow field plate 402 is annular in form having a fuel supply aperture 403. Branching flow field pattern 404 (part shown) connects fuel supply aperture 403 to a fuel drain 405. Land 406 is configured to receive seals and this configuration may take place either with the formation of the flow field or in a separate step.

The oxidant flow field on the underside of flow field plate 402 is the reverse, with oxidant flowing in from the outer edge of the flow field plate 402 to an inner drain 407. Several flow field stacks using such flow field plates may be used in a common housing as shown in FIG. 14. Chamber 410 houses a plurality of fuel cell stacks 411 which have fuel supplied through central apertures 412 and oxidant is supplied to and fills the chamber in the spaces 413 between the stacks. Waste materials from drains 405 and 407 are removed from manifolds either at the same end or opposite ends of the stacks.

Of course the whole arrangement can be reversed (oxidant up the middle and fuel at the outside) but for safety reasons the arrangement shown is preferred. With this arrangement it would also be possible to fill the fuel supply aperture 403 with storage means for fuel. This could provide a compact battery-like energy source that could be recharged.

The arrangement of FIGS. 13 and 14 is not limited to circular flow field plates, although conventional flow field plates are rectangular in form which gives rise to problems with sealing at the corners. A circular or oval geometry for the seals may be advantageous. A circular arrangement is not ideal for applying pressure to the fuel cell stack however, and as shown in FIG. 13 a hexagonal plate could conveniently be used with fixing holes at the corners to receive threaded rods or other means for tightening the stack.

As mentioned above, when forming flow field plates by the abrasive blast technique, different sized abrasives may be used to form the different sized channels. Abrasives of a variety of sizes may be mixed to form a blend. FIG. 15 shows an abrasive gun for use in such a technique in which a body 601 has an incoming high pressure gas supply pipe 602 and two abrasive delivery pipes 603 and 604. The blast of air from pipe 602 draws in abrasive from delivery pipes 603 and 604 which may be independently regulated if desired. The blast of air incorporating the abrasive passes down pipe 605 which serves to restrict the divergence of the air blast. A typical divergence in conventional sandblasting would be about 10°, although this can be reduced by lengthening the pipe 605 or placing an aperture downstream of the pipe 605 exit to remove a portion of the blast having most divergence. If desired the blast can be spread by shortening the pipe or placing an impediment at the centre of the air blast to divert it sideways (in the latter case a loss of abrasive momentum would be seen).

A multiple headed gun may also be used according to the invention. This is advantageous in forming both undercut and straight-sided channels. FIG. 16 shows a gun 501 with two heads 502 for simplicity, but it should be understood that the invention may be used with one or more heads, and preferably three heads. Each head is mounted on the head such that the angles of incidence, β_{A} and β_{B}, of the jet of blast material 503 may be varied. To effectively abrade the substrate 506, this angle is limited by the thickness, dᵣ, of the resist 504 and the width of the aperture in the mask, wᵣ as described above. Voids 505 may be formed in the substrate 506 using this multiple head in two ways.

Firstly, the multiple headed gun may simply be traversed across the substrate so that the jets of blast material are directed so as to form an undercut void, 505. For a multiple headed gun comprising three heads, the third is preferably directed at 90° to the substrate to ensure that a void with a flat bottom is formed.

Secondly, the multiple headed gun may rotate about an axis 508 out of the plane of (and preferably perpendicular to) the plane of the substrate 506, creating a substantially conical blast. This is particularly advantageous for ensuring that voids or apertures through the substrate are undercut uniformly. Of course, a single angled gun rotated about an axis out of the plane of (and preferably perpendicular to) the plane of the substrate 506 would achieve a similar effect but multiple guns mean that the rotational speed of the head may be kept lower.

If the point of the conical blast meets at the surface of the substrate then the abrasive particles may interfere with each other. If however the point is below the surface of the substrate then the blast will describe a circle or ellipse on the surface reducing such interference.

In the abrasive blast technique as described in WO01/04982 the gun traverses the plate in one direction as the plate moves under the gun in a non-parallel direction so that the blast passes across the plate in a raster fashion. (It is evident that the gun could stay still while the plate is moved but this is more complex to engineer). It is ordinarily advantageous to maintain uniform traversing speeds, but for geometries that are intended to differ significantly from side to side (e.g. that of FIG. 12) it may be of advantage to vary either the speed of the gun or of the plate to achieve different depths of cut. Another geometry that could be created using this technique would be similar to FIG. 12 but have generally straight channels 304 that progressively got shallower from fuel gas supply channel 305 to fuel gas drain channel 306.

It will be apparent that many of the flow field plate features described above are achievable by other means than abrasive blasting through a mask (e.g. injection moulding of suitable materials, excimer laser ablation).

Machining carbon based materials by an abrasive blast method will produce a lot of carbon dust and means must be provided to deal with this and prevent it becoming an explosive risk. Use of air classifiers, or other such means for separating particles by size and/or weight, in the circulation of abrasive will permit the separation of the carbon and this can be disposed of, for example, by passing through a flame to burn it off.

Air classifiers will also allow the separation of fine abrasive particles from coarse and these can be passed to separate guns where required.

It is known to provide flow field plates comprising an electrically conductive core and a non-conductive frame (e.g. WO97/50139, WO01/89019, and U.S. Pat. No. 3,278,336). The flow fields of the present invention may be used in such arrangements, with either the entire flow field being on the conductive core, or being partially on the non-conductive frame and partially on the conductive core. In particular the source and/or the drain for fluid may be on the non-conductive frame. In such arrangements the channels may change in cross-sectional area only on the conductive core, and in particular may taper only in that area lying under the electrochemically active region of the membrane electrode assembly.

The separate integers and combinations described above may form inventions in their own right.

1. A flow field plate for a proton exchange membrane fuel cell or electrolyser, comprising at least one channel extending from a source of fluid on the plate to a drain for said fluid on the plate, in which the cross-sectional area of said channel at drain or source is less than 95% of the cross-sectional area at source or drain respectively.

2. A flow field plate, as claimed in claim 1, in which the cross-sectional area of said channel at drain or source is less than 75% of the cross-sectional area at source or drain respectively.

3. A flow field plate, as claimed in claim 1 or claim 2, in which the channel crosses an electrochemically active region in the flow field, with the cross-sectional area of said channel at one side of said electrochemically active region being less than 95% of the cross-sectional area at another side of the electrochemically active region.

4. A flow field plate, as claimed in any preceding claim, in which the channel is branched.

5. A flow field plate, as claimed in any preceding claim, in which the channel changes in width along its length.

6. A flow field plate, as claimed in any preceding claim, in which the channel changes in depth along its length.

7. A flow field plate, as claimed in any preceding claim, in which the channel changes in area along its length non-uniformly.

8. A flow field plate, as claimed in any preceding claim, comprising an electrically conductive core and a non-conductive frame.

9. A flow field plate, as claimed in claim 8, in which the source and/or drain lies on the non-conductive frame.

10. A flow field plate, as claimed in claim 9, in which the channels change in cross-sectional area only on the conductive core.

11. A proton exchange membrane fuel cell or electrolyser comprising a plurality of flow field plates as claimed in any preceding claim.
